(19) United States
(12) Patent Application Publication
(10) Pub. No.: US 2024/0303933 A1
(43) Pub. Date: Sep. 12, 2024

(54) COMPANION DIGITAL HUMAN

(71) Applicant: International Business Machines Corporation, Armonk, NY (US)

(72) Inventors: Yuan Yuan Ding, Shanghai (CN); Ke Yong Zhang, Shanghai (CN); Ya Juan Dang, Beijing (CN); Tian Tian Chai, Beijing (CN); Yu Pan, Shanghai (CN); Ze Wang, Beijing (CN)

(21) Appl. No.: 18/180,898

(22) Filed: Mar. 9, 2023

(51) Int. Cl. G06T 19/00; G06T 15/10; G06V 20/50; G06V 20/64

(52) U.S. Cl. CPC G06T 19/003; G06T 15/10; G06T 19/006; G06V 20/50; G06V 20/64

(57) ABSTRACT

A computer-implemented method for providing a user with a digital companion in a three-dimensional (3D) environment is provided. The computer-implemented method includes recognizing content of the 3D environment, obtaining a point-of-view (POV) of the user in the 3D environment, displaying the digital companion to the user in the 3D environment based on the content and the POV, moving the digital companion through the 3D environment with the user while continuing the displaying and executing communicative interaction between the digital companion and the user based on the content and one or more communications of the user.

### BACKGROUND

The present invention generally relates to a companion digital human, and more specifically, to a companion digital human based on environmental understanding and intelligent dialogue.

A computer can be programmed to carry out a complex series of actions automatically and can be guided by an external control device by controls embedded within the computer itself. In some cases, computers can be provided as robots and/or as virtual or augmented reality persons or digital avatars that can be constructed or designed to evoke human form.

A digital avatar can be defined as an electronic image that represents a user that may be manipulated by the user. Digital humans are a subcategory of avatars. For example, while avatars come in different styles (cartoonish, abstract, artistic, etc.), digital humans may be indistinguishable from real people. Digital humans are designed so that other digital avatars or real people can interact with them. The human likeness of digital humans combined with artificial intelligence (AI) makes communication feel authentic, which is why digital humans have a huge potential to radically change our online interactions.

### SUMMARY

Embodiments of the present invention are directed to a computer-implemented method for providing a user with a digital companion in a three-dimensional (3D) environment. The computer-implemented method includes recognizing content of the 3D environment, obtaining a point-of-view (POV) of the user in the 3D environment, displaying the digital companion to the user in the 3D environment based on the content and the POV, moving the digital companion through the 3D environment with the user while continuing the displaying and executing communicative interaction between the digital companion and the user based on the content and one or more communications of the user.

As a result of an execution of the computer-implemented method, a digital companion for a person is proposed to accompany tourists/customers for business handling or sightseeing. The digital companion can largely replace physical robots and free human hands. The digital companion can be communicative in a natural manner with a user and can be provided with an ability to follow the user through a virtual or augmented reality in a natural manner using obstacle avoidance algorithms. The digital companion can also be designed for and implemented on multiple platforms.

In accordance with additional or alternative embodiments of the invention, the 3D environment is at least one of a fully virtual environment and an augmented reality (AR) environment and the displaying of the digital companion is accomplished via one or more of a mobile phone, augmented reality (AR) glasses and a computing device.

In accordance with additional or alternative embodiments of the invention, an appearance of the digital companion is customizable.

In accordance with additional or alternative embodiments of the invention, the moving of the digital companion through the 3D environment comprises obstacle avoidance.

In accordance with additional or alternative embodiments of the invention, the executing of the communicative interaction between the digital companion and the user includes at least one of natural language processing, automated speech recognition and text-to-speech operations.

In accordance with additional or alternative embodiments of the invention, the digital companion is one or more of a digital hotel manager, a digital museum guide and a digital hospital escort.

Embodiments of the invention further provide computer program products and computer systems having substantially the same features and technical benefits as the above-described computer-implemented methods.

Additional technical features and benefits are realized through the techniques of the present invention. Embodiments and aspects of the invention are described in detail herein and are considered a part of the claimed subject matter. For a better understanding, refer to the detailed description and to the drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the embodiments of the invention are apparent from the following detailed description taken in conjunction with the accompanying drawings in which:

FIG. 1 is a block diagram of components of a machine learning training and inference system according to one or more embodiments of the present invention;

FIG. 2 is a flow diagram illustrating a computer-implemented method for providing a user with a digital companion in a three-dimensional (3D) environment in accordance with one or more embodiments of the present invention;

FIG. 3 is a flow diagram illustrating an execution of the computer-implemented method 200 of FIG. 2 in accordance with one or more embodiments of the present invention;

FIG. 4 illustrates an operation of a digital companion in a hotel case in accordance with one or more embodiments of the present invention;

FIG. 5 illustrates an operation of a digital companion in a museum case in accordance with one or more embodiments of the present invention;

FIG. 6 illustrates an operation of a digital companion in a hospital case in accordance with one or more embodiments of the present invention; and

FIG. 7 is a schematic diagram of a computing environment for executing the computer-implemented method of FIG. 3 in accordance with one or more embodiments of the present invention.

The diagrams depicted herein are illustrative. There can be many variations to the diagram or the operations described therein without departing from the spirit of the invention. For instance, the actions can be performed in a differing order or actions can be added, deleted or modified. Also, the term “coupled” and variations thereof describes having a communications path between two elements and does not imply a direct connection between the elements with no intervening elements/connections between them. All of these variations are considered a part of the specification.

In the accompanying figures and following detailed description of the disclosed embodiments, the various elements illustrated in the figures are provided with two or three digit reference numbers. With minor exceptions, the leftmost digit(s) of each reference number correspond to the figure in which its element is first illustrated.

### DETAILED DESCRIPTION

Turning now to an overview of technologies that are more specifically relevant to aspects of the invention, there are a variety of robots that can replace humans to serve consumers in a variety of situations. For example, unmanned hotels can use robots to check-in for tourists, intelligent tourist guides in tourist attractions can provide tourists with information about various cultural relics and some financial business, such as banks, are introducing robots to handle banking business for customers.

Although the use of physical robots to provide help for consumers or customers can liberate humans from doing so to a certain extent, there are in fact still many problems with robots. Robots are generally expensive and difficult to humanize. Robots are prone to various faults, difficult to maintain, often require complex system updates and have limited support. With increased demand of robotics, one-to-one services are often not achievable and usage scenarios are limited.

With the continuous development of meta-universe applications and augmented reality (AR) technology, increasing numbers and types of consumer-grade AR glasses have flooded into the market. It is now becoming possible for digital-human customer service to replace physical robots for the same tasks (and for digital-human services to replace robots in other scenarios as well). Compared with traditional physical robots, digital humans are lighter and more realistic, and can provide one-to-one services with a wide range of application scenarios. Nevertheless, the technology of digital humans still needs to be developed as there are several outstanding issues remaining unresolved.

Turning now to an overview of the aspects of the invention, one or more embodiments of the invention address shortcomings of the above-described approach by providing for a companion digital human that can be implemented on a variety of platforms, including mobile phones, AR glasses, the web, etc. The companion digital human can be customized with various forms according to the application scene. There would be no requirement or limit on the number of users for the companion digital human, which can offer one-to-one services, can accompany users or customers throughout whole processes, answer customers' questions and make use of artificial intelligence (AI) technology to interact with customers in a natural manner. In addition, as a companion digital human appears to move through a virtual or real environment, the companion digital human can automatically avoid obstacles according to data collected by sensors to accurately simulate human actions and feelings.

The above-described aspects of the invention address the shortcomings of known approaches by providing for

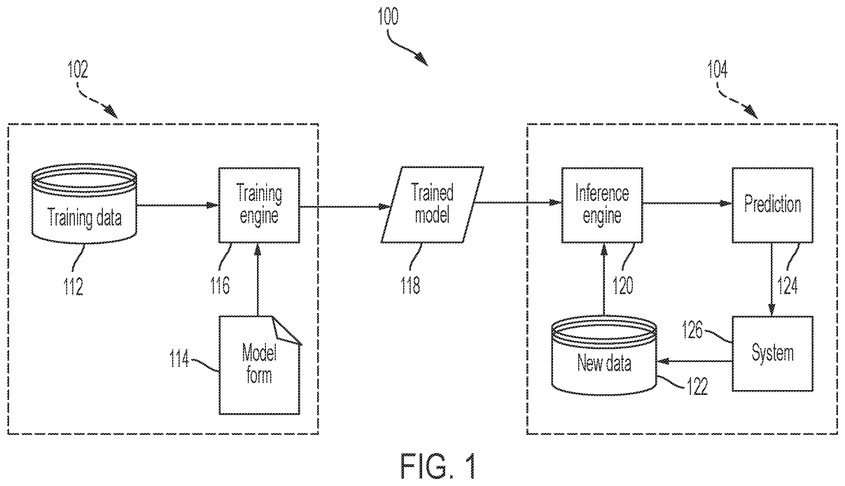

Turning now to a more detailed description of aspects of the present invention, FIG. 1 depicts a block diagram of components of a machine learning training and inference system 100. The machine learning training and inference system 100, in accordance with one or more embodiments of the invention, can utilize machine learning techniques to perform tasks, such as augmentation and printing of a 3D object. More specifically, one or more embodiments of the invention described herein can incorporate and utilize rule-based decision making and artificial intelligence (AI) reasoning to accomplish the various operations described herein, namely analyzing a model of the 3D object, information of sensors for deployment on the 3D object and environmental parameters of a location where the 3D object is deployable, determining, from results of the analyzing, a surface contour of the 3D object, power requirements of the sensors and power levels that can be generated at the location by algae-based power generation, augmenting the model with microfluidic circuitry models for supporting the algae-based power generation on the surface contour to meet the power requirements to an extent possible given the power levels, printing the 3D object and microfluidic circuitry according to the model and the microfluidic circuitry models and supplying the microfluidic circuitry with algae for the algae-based power generation.

Embodiments of the invention utilize AI, which includes a variety of so-called machine learning technologies. The phrase “machine learning” broadly describes a function of electronic systems that learn from data. A machine learning system, engine, or module can include a trainable machine learning algorithm that can be trained, such as in an external cloud environment, to learn functional relationships between inputs and outputs, and the resulting model (sometimes referred to as a “trained neural network,” “trained model,” and/or “trained machine learning model”) can be used for managing information during a web conference, for example. In one or more embodiments of the invention, machine learning functionality can be implemented using an artificial neural network (ANN) having the capability to be trained to perform a function. In machine learning and cognitive science, ANNs are a family of statistical learning models inspired by the biological neural networks of animals, and in particular the brain. ANNs can be used to estimate or approximate systems and functions that depend on a large number of inputs. Convolutional neural networks (CNN) are a class of deep, feed-forward ANNs that are particularly useful at tasks such as, but not limited to analyzing visual imagery and natural language processing (NLP). Recurrent neural networks (RNN) are another class of deep, feed-forward ANNs and are particularly useful at tasks such as, but not limited to, unsegmented connected handwriting recognition and speech recognition. Other types of neural networks are also known and can be used in accordance with one or more embodiments of the invention described herein.

ANNs can be embodied as so-called “neuromorphic” systems of interconnected processor elements that act as simulated “neurons” and exchange “messages” between each other in the form of electronic signals. Similar to the so-called “plasticity” of synaptic neurotransmitter connections that carry messages between biological neurons, the connections in ANNs that carry electronic messages between simulated neurons are provided with numeric weights that correspond to the strength or weakness of a given connection. The weights can be adjusted and tuned based on experience, making ANNs adaptive to inputs and capable of learning. For example, an ANN for handwriting recognition is defined by a set of input neurons that can be activated by the pixels of an input image. After being weighted and transformed by a function determined by the network's designer, the activation of these input neurons are then passed to other downstream neurons, which are often referred to as “hidden” neurons. This process is repeated until an output neuron is activated. The activated output neuron determines which character was input. It should be appreciated that these same techniques can be applied in the case of localizing a target object referred by a compositional expression from an image set with similar visual elements as described herein.

The machine learning training and inference system 100 performs training 102 and inference 104. During training 102, a training engine 116 trains a model (e.g., the trained model 118) to perform a task. Inference 104 is the process of implementing the trained model 118 to perform the task in the context of a larger system (e.g., a system 126).

The training 102 begins with training data 112, which can be structured or unstructured data. The training engine 116 receives the training data 112 and a model form 114. The model form 114 represents a base model that is untrained. The model form 114 can have preset weights and biases, which can be adjusted during training. It should be appreciated that the model form 114 can be selected from many different model forms depending on the task to be performed. For example, where the training 102 is to train a model to perform image classification, the model form 114 can be a model form of a CNN (convolutional neural network). The training 102 can be supervised learning, semi-supervised learning, unsupervised learning, reinforcement learning, and/or the like, including combinations and/or multiples thereof. For example, supervised learning can be used to train a machine learning model to classify an object of interest in an image. To do this, the training data 112 includes labeled images, including images of the object of interest with associated labels (ground truth) and other images that do not include the object of interest with associated labels. In this example, the training engine 116 takes as input a training image from the training data 112, makes a prediction for classifying the image, and compares the prediction to the known label. The training engine 116 then adjusts weights and/or biases of the model based on results of the comparison, such as by using backpropagation. The training 102 can be performed multiple times (referred to as “epochs”) until a suitable model is trained (e.g., the trained model 118).

Once trained, the trained model 118 can be used to perform inference 104 to perform a task. The inference engine 120 applies the trained model 118 to new data 122 (e.g., real-world, non-training data). For example, if the trained model 118 is trained to classify images of a particular object, such as a chair, the new data 122 can be an image of a chair that was not part of the training data 112. In this way, the new data 122 represents data to which the model 118 has not been exposed. The inference engine 120 makes a prediction 124 (e.g., a classification of an object in an image of the new data 122) and passes the prediction 124 to the system 126. The system 126 can, based on the prediction 124, taken an action, perform an operation, perform an analysis, and/or the like, including combinations and/or multiples thereof. In some embodiments of the invention, the system 126 can add to and/or modify the new data 122 based on the prediction 124.

In accordance with one or more embodiments of the invention, the predictions 124 generated by the inference engine 120 are periodically monitored and verified to ensure that the inference engine 120 is operating as expected. Based on the verification, additional training 102 can occur using the trained model 118 as the starting point. The additional training 102 can include all or a subset of the original training data 112 and/or new training data 112. In accordance with one or more embodiments of the invention, the training 102 includes updating the trained model 118 to account for changes in expected input data.

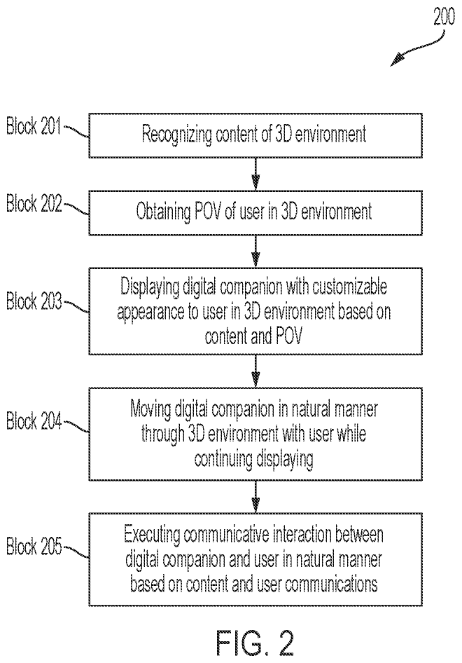

With reference to FIG. 2, a computer-implemented method 200 is provided for providing a user with a digital companion in a three-dimensional (3D) environment. As shown in FIG. 2, the computer-implemented method 200 includes recognizing content of the 3D environment (block 201), obtaining a point-of-view (POV) of the user in the 3D environment (block 202), displaying the digital companion with a customizable appearance to the user in the 3D environment based on the content and the POV (block 203), moving the digital companion in a natural manner through the 3D environment with the user while continuing the displaying (block 204) and executing communicative interaction between the digital companion and the user in a natural manner based on the content and one or more communications of the user (block 205).

The 3D environment can be provided as a fully virtual environment or as an augmented reality (AR) environment. In these or cases, the displaying of the digital companion of block 203 can be accomplished via one or more of a mobile phone, augmented reality (AR) glasses and a computing device. The moving of the digital companion in the natural manner through the 3D environment of block 204 includes obstacle identification and avoidance and the executing of the communicative interaction between the digital companion and the user in the natural manner of block 205 includes at least one of natural language processing, automated speech recognition and text-to-speech operations. With the computer-implemented method 200 provided as described herein, the digital companion can be provided as one or more of a digital hotel manager, a digital museum guide and a digital hospital escort.

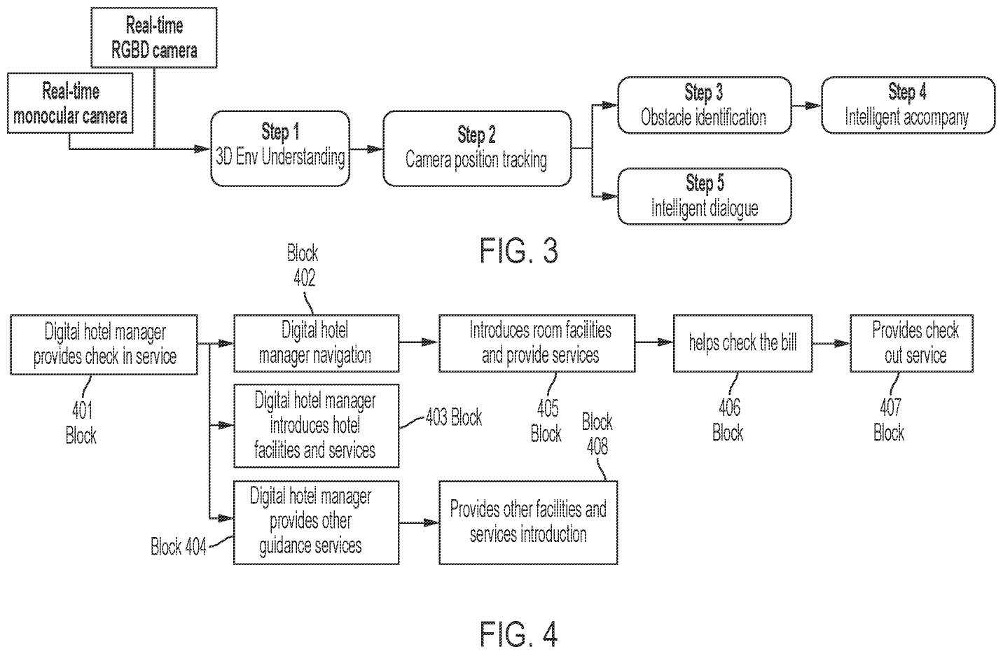

With reference to FIG. 3, an execution of the computer-implemented method 200 of FIG. 2 is illustrated schematically. As shown in FIG. 2, in step 1, the recognizing of the content of the 3D environment is at least partially achieved by receiving input from at least one of a real-time RGBD camera 301 and a monocular camera 302. In greater detail, related feature points are determined and calculated from the inputs, all feature points are collected to build cloud points of the 3D environment and the cloud points of the 3D environment are used to develop an understanding of the 3D environment for the digital companion.

In step 2, camera position tracking is executed to support the displaying of the digital companion with the customizable appearance to the user in the 3D environment based on the content and the POV of block 203. Here, a camera position (x, y, z) is calculated based on tracking. From this, a camera pose or position and location can be calculated in real-time.

In step 3, obstacle identification is executed to support the moving of the digital companion in the natural manner through the 3D environment with the user of block 204. The obstacle identification can be divided into three parts: (1) visual occlusion recognition, (2) obstacle recognition when the digital companion is moving and (3) a plane splicing algorithm. For the visual occlusion recognition, by detecting depth information of feature points and associating the depth information with the location of the digital companion, obstacles in front of the digital companion can be identified and will have more priority to be rendered to achieve the effect of occlusion. For the obstacle recognition when the digital companion is moving, a hit test will be performed. This hit test will detect whether there is an intersection between an imaged ray and any horizontal plane and will identify whether there is an obstacle in front of digital companion. For the plane splicing algorithm, a new plane is detected and all surrounding planes are acquired. A height difference between two planes is estimated. In an event that no estimate exceeds a given threshold, it is then determined whether there is any overlap between two planes. In an event that an estimate exceeds a given threshold, no splicing is done. In an event that it is determined that there is an overlap between two planes, it is determined that there is an integrated boundary of nodes of two planes. In an event that it is determined that there is no overlap between two planes, it is determined whether any feature points exist with particularly large height differences. In an event it is determined that no feature points exist with particularly large height differences, it is determined that there is an integrated boundary of nodes of two planes. In an event it is determined that feature points exist with particularly large height differences, no splicing is done.

In addition to the above, an obstacle avoidance process can include the following operations. Given a current position of the digital companion as a starting point and an end point, a direction of movement is established. In each frame, it is detected whether there are obstacles on the front of digital companion along the direction and with the distance of each step unit. If obstacles are detected, turn the direction by unit degrees and perform obstacle detection again. Repeat this step until no obstacles are found. The process as a whole is then repeated until the digital companion reaches the destination or is within some predefined distance from the destination.

In steps 4 and 5, intelligent accompanying and dialoguing are executed to support the executing of the communicative interaction between the digital companion and the user in the natural manner based on the content and user communications of block 205. For the intelligent accompanying, a pose and position of the camera are tracked in real-time. In an event the camera moves beyond a certain distance, the digital companion automatically moves toward the camera. When the camera is pointed at one place for a given time (i.e., a few seconds), it is determined whether the target of the camera is reachable. If so, the digital companion is moved to the target. For the intelligent dialoguing, the user can use various devices, such as a mobile phone, to communicate, the digital companion can be integrated with a bot chat application and can use text-to- speech applications as well as automated speech recognition and/or natural language processing to conduct dialogues with the user.

With reference to FIG. 4, in hotels and other similar establishments, there is a queuing phenomenon in check-in and check-out during peak periods, especially when there are fewer personnel on duty. There is also often a lack of hotel room guidance service except for written materials that are not updated easily. Thus, hotel layout and service facilities can be missing or insufficient. The digital companion addresses these concerns by providing self-service check-in and check-out service, providing hotel room guidance service with a 3D introduction and instruction to hotel room facilities as well as hotel layout and service facilities guidance.

As shown in FIG. 4, when a user arrives at a hotel, the digital companion provides a check-in service (block 401). Subsequently, the digital companion can provide hotel navigation (block 402), an introduction to hotel facilities and services (block 403) and other guidance services (block 404). For the hotel navigation of block 402, the digital companion can provide introductions to room facilities and services (block 405), a bill checking service (block 406) and check-out service (block 407). For the other guidance services of (block 404), the digital companion can provide introductions to other facilities and services (block 408).

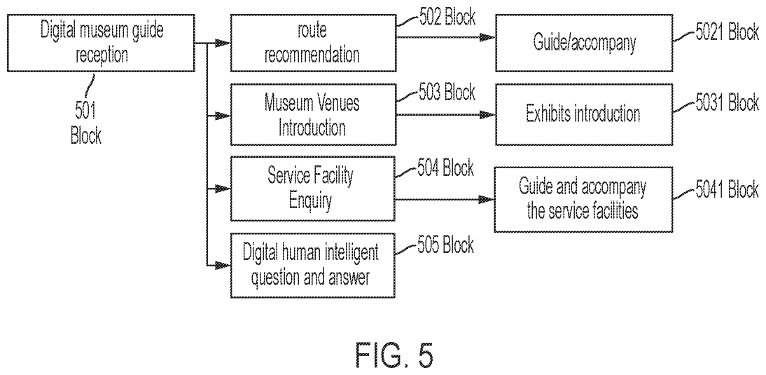

With reference to FIG. 5, in museums and other similar establishments, individual guides are expensive whereas group guides only provide guided tours at a specific pace and route. Meanwhile, content provided by an audio tour guide is rigid and has no affinity and thus interaction between visitors and venues is low, and questions cannot be answered easily. Meanwhile, searching for information about exhibits through smart phones does not free visitors' eyes and hands. The digital companion can address these concerns by providing personalized tour services that can be customized for route and pace with one-to-one service. Smart glasses and other similar devices can enhance the experience and make sightseeing easier.

As shown in FIG. 5, when a user arrives at a museum, he/she is received by the digital companion (block 501). The digital companion then provides route recommendations (block 502) with guidance and accompaniment (block 5021), an introduction to museum venues (block 503) with exhibit introductions (block 5031), responses to facilities enquiries (block 504) with guidance and accompaniment to those facilities (block 5041) and permits question and answer sessions (block 505).

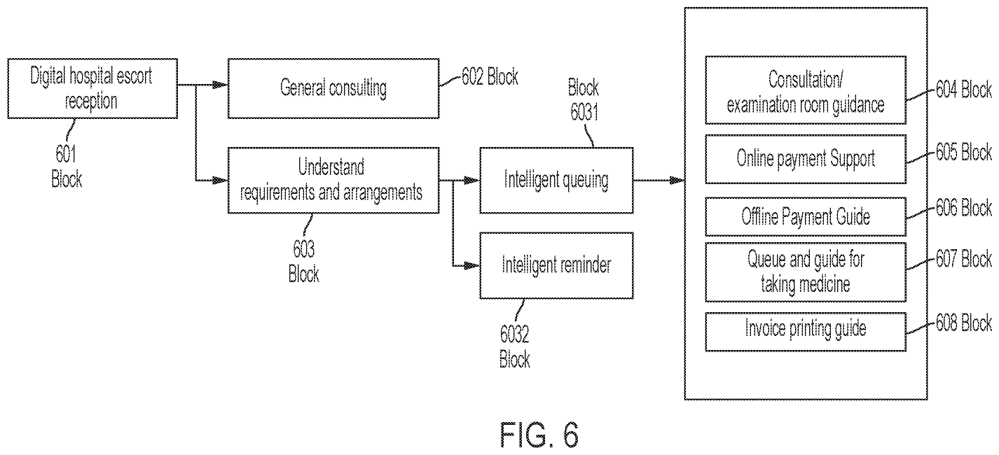

With reference to FIG. 6, queuing at hospital service desks can be a serious problem as time may be short before patients need assistance. Also, in general, hospitals have no indoor navigation so that finding a room is difficult especially for the elderly or other patients with physical disorders. A queue status for a patient might only be reviewable on a large screen with no capabilities to remind staff. Also, when multiple office visits are required for a patient, an optimal path cannot be obtained in advance. Finally, personal hospital accompaniment services are often very expensive. The digital companion addresses these concerns by helping to answer questions, offering escort services and indoor guidance and provided intelligent notification of queuing status.

As shown in in FIG. 6, when a user arrives at a hospital, he/she is received by the digital companion (block 601). The digital companion can then provide general consulting (block 602) and an understanding of requirements and arrangements (block 603) with intelligent queuing (block 6031) and intelligent reminders (block 6032). For the intelligent queuing of block 6031, the digital companion can provide consultation/examination room guidance (block 604), online payment support (block 605), offline payment guidance (block 606), guidance for medicine taking (block 607) and invoice printing guidance (block 608).

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

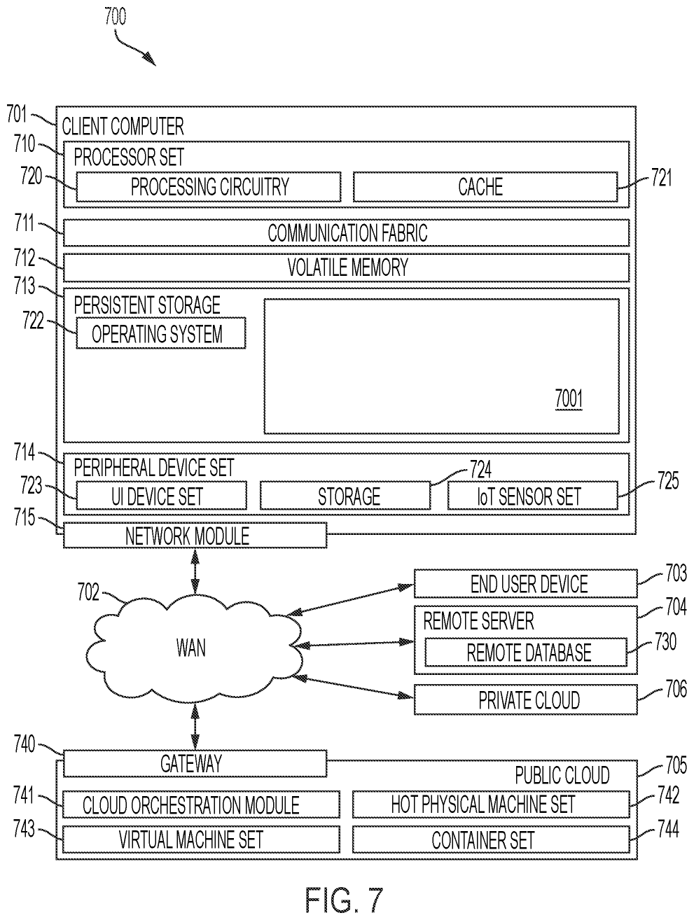

With reference to FIG. 7, a computer or computing device 700 that implements the computer-implemented method 200 of FIG. 3 in accordance with one or more embodiments of the present invention is provided. The computer or computing device 700 of FIG. 7 contains an example of an environment for the execution of at least some of the computer code involved in performing the inventive methods, such as the block 7001 of the computer-implemented method 200 of FIG. 2 for processing data connection requests. In addition to the block 7001 of the computer-implemented method 200, the computer or computing device 700 includes, for example, computer 701, wide area network (WAN) 702, end user device (EUD) 703, remote server 704, public cloud 705, and private cloud 706. In this embodiment, computer 701 includes processor set 710 (including processing circuitry 720 and cache 721), communication fabric 711, volatile memory 712, persistent storage 713 (including operating system 722 and the block 7001 of the computer-implemented method 200, as identified above), peripheral device set 714 (including user interface (UI) device set 723, storage 724, and Internet of Things (IoT) sensor set 725), and network module 715. Remote server 704 includes remote database 730. Public cloud 705 includes gateway 740, cloud orchestration module 741, host physical machine set 742, virtual machine set 743, and container set 744.

The computer 701 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 730. As is well understood in the art of computer technology, and depending upon the technology, performance of a computer-implemented method may be distributed among multiple computers and/or between multiple locations. On the other hand, in this presentation of the computer-implemented method 200 of FIG. 2, detailed discussion is focused on a single computer, specifically computer 701, to keep the presentation as simple as possible. Computer 701 may be located in a cloud, even though it is not shown in a cloud in FIG. 7. On the other hand, computer 701 is not required to be in a cloud except to any extent as may be affirmatively indicated.

The processor set 710 includes one, or more, computer processors of any type now known or to be developed in the future. Processing circuitry 720 may be distributed over multiple packages, for example, multiple, coordinated integrated circuit chips. Processing circuitry 720 may implement multiple processor threads and/or multiple processor cores. Cache 721 is memory that is located in the processor chip package(s) and is typically used for data or code that should be available for rapid access by the threads or cores running on processor set 710. Cache memories are typically organized into multiple levels depending upon relative proximity to the processing circuitry. Alternatively, some, or all, of the cache for the processor set may be located “off chip.” In some computing environments, processor set 710 may be designed for working with qubits and performing quantum computing.

Computer readable program instructions are typically loaded onto computer 701 to cause a series of operational steps to be performed by processor set 710 of computer 701 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 721 and the other storage media discussed below. The program instructions, and associated data, are accessed by processor set 710 to control and direct performance of the inventive methods. In the computer-implemented method 200 of FIG. 2, at least some of the instructions for performing the inventive methods may be stored in the block 7001 of the computer-implemented method 200 in persistent storage 713.

Communication fabric 711 is the signal conduction path that allows the various components of computer 701 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 712 is any type of volatile memory now known or to be developed in the future. Examples include dynamic type random access memory (RAM) or static type RAM. Typically, volatile memory 712 is characterized by random access, but this is not required unless affirmatively indicated. In computer 701, the volatile memory 712 is located in a single package and is internal to computer 701, but, alternatively or additionally, the volatile memory may be distributed over multiple packages and/or located externally with respect to computer 701.

Persistent storage 713 is any form of non-volatile storage for computers that is now known or to be developed in the future. The non-volatility of this storage means that the stored data is maintained regardless of whether power is being supplied to computer 701 and/or directly to persistent storage 713. Persistent storage 713 may be a read only memory (ROM), but typically at least a portion of the persistent storage allows writing of data, deletion of data and re-writing of data. Some familiar forms of persistent storage include magnetic disks and solid state storage devices. Operating system 722 may take several forms, such as various known proprietary operating systems or open source Portable Operating System Interface-type operating systems that employ a kernel. The code included in the block 7001 of the computer-implemented method 200 typically includes at least some of the computer code involved in performing the inventive methods.

Peripheral device set 714 includes the set of peripheral devices of computer 701. Data communication connections between the peripheral devices and the other components of computer 701 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 723 may include components such as a display screen, speaker, microphone, wearable devices (such as goggles and smart watches), keyboard, mouse, printer, touchpad, game controllers, and haptic devices. Storage 724 is external storage, such as an external hard drive, or insertable storage, such as an SD card. Storage 724 may be persistent and/or volatile. In some embodiments, storage 724 may take the form of a quantum computing storage device for storing data in the form of qubits. In embodiments where computer 701 is required to have a large amount of storage (for example, where computer 701 locally stores and manages a large database) then this storage may be provided by peripheral storage devices designed for storing very large amounts of data, such as a storage area network (SAN) that is shared by multiple, geographically distributed computers. IoT sensor set 725 is made up of sensors that can be used in Internet of Things applications. For example, one sensor may be a thermometer and another sensor may be a motion detector.

Network module 715 is the collection of computer software, hardware, and firmware that allows computer 701 to communicate with other computers through WAN 702. Network module 715 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 715 are performed on the same physical hardware device. In other embodiments (for example, embodiments that utilize software-defined networking (SDN)), the control functions and the forwarding functions of network module 715 are performed on physically separate devices, such that the control functions manage several different network hardware devices. Computer readable program instructions for performing the inventive methods can typically be downloaded to computer 701 from an external computer or external storage device through a network adapter card or network interface included in network module 715.

WAN 702 is any wide area network (for example, the internet) capable of communicating computer data over non-local distances by any technology for communicating computer data, now known or to be developed in the future. In some embodiments, the WAN 702 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 703 is any computer system that is used and controlled by an end user (for example, a customer of an enterprise that operates computer 701), and may take any of the forms discussed above in connection with computer 701. EUD 703 typically receives helpful and useful data from the operations of computer 701. For example, in a hypothetical case where computer 701 is designed to provide a recommendation to an end user, this recommendation would typically be communicated from network module 715 of computer 701 through WAN 702 to EUD 703. In this way, EUD 703 can display, or otherwise present, the recommendation to an end user. In some embodiments, EUD 703 may be a client device, such as thin client, heavy client, mainframe computer, desktop computer and so on.

Remote server 704 is any computer system that serves at least some data and/or functionality to computer 701. Remote server 704 may be controlled and used by the same entity that operates computer 701. Remote server 704 represents the machine(s) that collect and store helpful and useful data for use by other computers, such as computer 701. For example, in a hypothetical case where computer 701 is designed and programmed to provide a recommendation based on historical data, then this historical data may be provided to computer 701 from remote database 730 of remote server 704.

Public cloud 705 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 705 is performed by the computer hardware and/or software of cloud orchestration module 741. The computing resources provided by public cloud 705 are typically implemented by virtual computing environments that run on various computers making up the computers of host physical machine set 742, which is the universe of physical computers in and/or available to public cloud 705. The virtual computing environments (VCEs) typically take the form of virtual machines from virtual machine set 743 and/or containers from container set 744. It is understood that these VCEs may be stored as images and may be transferred among and between the various physical machine hosts, either as images or after instantiation of the VCE. Cloud orchestration module 741 manages the transfer and storage of images, deploys new instantiations of VCEs and manages active instantiations of VCE deployments. Gateway 740 is the collection of computer software, hardware, and firmware that allows public cloud 705 to communicate through WAN 702.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 706 is similar to public cloud 705, except that the computing resources are only available for use by a single enterprise. While private cloud 706 is depicted as being in communication with WAN 702, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 705 and private cloud 706 are both part of a larger hybrid cloud.

Various embodiments of the invention are described herein with reference to the related drawings. Alternative embodiments of the invention can be devised without departing from the scope of this invention. Various connections and positional relationships (e.g., over, below, adjacent, etc.) are set forth between elements in the following description and in the drawings. These connections and/or positional relationships, unless specified otherwise, can be direct or indirect, and the present invention is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

The following definitions and abbreviations are to be used for the interpretation of the claims and the specification. As used herein, the terms “comprises,” “comprising,” “includes,” “including,” “has,” “having,” “contains” or “containing,” or any other variation thereof, are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any embodiment or design described herein as “exemplary” is not necessarily to be construed as preferred or advantageous over other embodiments or designs. The terms “at least one” and “one or more” may be understood to include any integer number greater than or equal to one, i.e. one, two, three, four, etc. The terms “a plurality” may be understood to include any integer number greater than or equal to two, i.e. two, three, four, five, etc. The term “connection” may include both an indirect “connection” and a direct “connection.”

The terms “about,” “substantially,” “approximately,” and variations thereof, are intended to include the degree of error associated with measurement of the particular quantity based upon the equipment available at the time of filing the application. For example, “about” can include a range of ±8% or 5%, or 2% of a given value.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments described herein.

What is claimed is:

1. A computer-implemented method for providing a user with a digital companion in a three-dimensional (3D) environment, the computer-implemented method comprising:
recognizing content of the 3D environment;
obtaining a point-of-view (POV) of the user in the 3D environment;
displaying the digital companion to the user in the 3D environment based on the content and the POV;
moving the digital companion through the 3D environment with the user while continuing the displaying; and
executing communicative interaction between the digital companion and the user based on the content and one or more communications of the user.

2. The computer-implemented method according to claim 1, wherein the 3D environment is at least one of a fully virtual environment and an augmented reality (AR) environment.

3. The computer-implemented method according to claim 1, wherein the displaying of the digital companion is accomplished via one or more of a mobile phone, augmented reality (AR) glasses and a computing device.

4. The computer-implemented method according to claim 1, wherein an appearance of the digital companion is customizable.

5. The computer-implemented method according to claim 1, wherein the moving of the digital companion through the 3D environment comprises obstacle avoidance.

6. The computer-implemented method according to claim 1, wherein the executing of the communicative interaction between the digital companion and the user comprises at least one of natural language processing, automated speech recognition and text-to-speech operations.

7. The computer-implemented method according to claim 1, wherein the digital companion is one or more of a digital hotel manager, a digital museum guide and a digital hospital escort.

8. A computer program product for providing a user with a digital companion in a three-dimensional (3D) environment, the computer program product comprising one or more computer readable storage media having computer readable program code collectively stored on the one or more computer readable storage media, the computer readable program code being executed by a processor of a computer system to cause the computer system to perform a method comprising:
recognizing content of the 3D environment;
obtaining a point-of-view (POV) of the user in the 3D environment;
displaying the digital companion to the user in the 3D environment based on the content and the POV;
moving the digital companion through the 3D environment with the user while continuing the displaying; and
executing communicative interaction between the digital companion and the user based on the content and one or more communications of the user.

9. The computer program product according to claim 8, wherein the 3D environment is at least one of a fully virtual environment and an augmented reality (AR) environment.

10. The computer program product according to claim 8, wherein the displaying of the digital companion is accomplished via one or more of a mobile phone, augmented reality (AR) glasses and a computing device.

11. The computer program product according to claim 8, wherein an appearance of the digital companion is customizable.

12. The computer program product according to claim 8, wherein the moving of the digital companion through the 3D environment comprises obstacle avoidance.

13. The computer program product according to claim 8, wherein the executing of the communicative interaction between the digital companion and the user comprises at least one of natural language processing, automated speech recognition and text-to-speech operations.

14. The computer program product according to claim 8, wherein the digital companion is one or more of a digital hotel manager, a digital museum guide and a digital hospital escort.

15. A computing system comprising:
a processor;
a memory coupled to the processor; and
one or more computer readable storage media coupled to the processor, the one or more computer readable storage media collectively containing instructions that are executed by the processor via the memory to implement a method for providing a user with a digital companion in a three-dimensional (3D) environment comprising:
recognizing content of the 3D environment;
obtaining a point-of-view (POV) of the user in the 3D environment;
displaying the digital companion to the user in the 3D environment based on the content and the POV;
moving the digital companion through the 3D environment with the user while continuing the displaying; and
executing communicative interaction between the digital companion and the user based on the content and one or more communications of the user.

16. The computing system according to claim 15, wherein:
the 3D environment is at least one of a fully virtual environment and an augmented reality (AR) environment, and
the displaying of the digital companion is accomplished via one or more of a mobile phone, augmented reality (AR) glasses and a computing device.

17. The computing system according to claim 15, wherein an appearance of the digital companion is customizable.

18. The computing system according to claim 15, wherein the moving of the digital companion through the 3D environment comprises obstacle avoidance.

19. The computing system according to claim 15, wherein the executing of the communicative interaction between the digital companion and the user comprises at least one of natural language processing, automated speech recognition and text-to-speech operations.

20. The computing system according to claim 15, wherein the digital companion is one or more of a digital hotel manager, a digital museum guide and a digital hospital escort.
